(19) United States
(12) Patent Application Publication
(10) Pub. No.: US 2026/0368268 A1
(43) Pub. Date: Nov. 19, 2026

(54) DYNAMIC AND PERSONALIZED DATA USING REAL-TIME DATA GRAPHS

(71) Applicant: Salesforce, Inc., San Francisco, CA (US)

(72) Inventors: Shyam Sundar Rao Mankala, HULIMAVU (IN); Tapas Kumar Nayak, Redmond, WA (US); Anil Kumar Nori, Redmond, WA (US); Vishal Chordia, Mountain View, CA (US); Jawad Ahmed Ibrahim Katib, Sammamish, WA (US)

(21) Appl. No.: 19/206,962

(22) Filed: May 13, 2025

(51) Int. Cl. G06F 16/9535; G06F 16/901

(52) U.S. Cl. CPC G06F 16/9535; G06F 16/9024

(57) ABSTRACT

Techniques for generating personalized data using real-time data graphs are discussed herein. A system may receive user data including a user action. The system may leverage a real-time layer such that a real-time data graph may be updated based on the user action. The system may use the real-time data graph to generate real-time personalization data. When generating real-time personalization data, the system may update a user profile. The system may leverage a storage layer such that a data graph may be updated based on the user action and/or other actions. The system may use the data graph of the storage layer to generate personalization data. Personalization data from the real-time layer and the storage layer may be used to generate one or more personalized outputs for a user.

### TECHNICAL FIELD

Companies may use one or more systems and/or platforms to perform various tasks. In some cases, systems and/or platforms may receive user data associated with a company (e.g., customer data). However, when requesting that the systems/or platforms perform an operation using such data for user personalization, the operations may result in an undesirable user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates a schematic view of an example system for determining real-time personalization data using real-time data graphs.

FIG. 2 illustrates a system-architecture diagram of an example system in which a system uses a real-time layer and storage layer for user data processing.

FIG. 3 illustrates a block diagram including an example process for the use of real-time data graphs by a generative machine learned model, and related user interfaces.

FIG. 4 illustrates an example environment for performing techniques described herein.

FIG. 5 is a flow diagram illustrating an example process of determining personalized data using real-time data graphs.

### DETAILED DESCRIPTION

Techniques for generating dynamic and personalized data using real-time data graphs are discussed herein. As described throughout, systems can leverage real-time data graphs such that personalization data that can be generated, updated, and/or accessed in real time. In some examples, a system may receive user data including a user action (e.g., browsing a webpage, clicking a user interface component, etc.). The system may leverage a real-time layer such that a real-time data graph may be generated and/or updated based on the user action. Accordingly, the system may use the real-time data graph to generate personalization data. When generating personalization data, the system may update and/or create a user profile, where the user profile may indicate attributes, actions, and/or the like associated with a user. The system may determine personalization data at a time at which the personalization data may be accessed and/or used in real-time. The system may also leverage a storage layer, where the storage layer may include a data graph. The storage layer may also receive the user data, and/or other data. The system may leverage the storage layer such that a data graph may be generated and/or updated based on the user action and/or other actions (e.g., non-real-time actions). The system may use the data graph to also generate personalization data. For example, the personalization data generated using the data graph of the storage layer may be used by the system to further update the user profile. The personalization data generated using the data graph of the storage layer may be determined at a time at which the personalization data may be accessed and/or used at a subsequent time (e.g., not real-time). Additionally, or alternatively, personalization data may be used to generate one or more personalized outputs for a user. As discussed throughout this disclosure, the techniques may improve the user experience by allowing the system to generate and/or update personalization data in real time, such that particular user engagements are immediately available in a user profile, and usable to make decisions and personalize interactions before a user's subsequent engagement.

When personalizing a user experience of an application, such as a web application, mobile application, customer relationship management (CRM) platform, and/or the like, it may be beneficial to provide such personalization in real time. Personalizing a user experience may be context-driven. For example, companies (e.g., organizations), and/or users may rely on various systems to store and manage user (e.g., customer) data. In such cases, vast amounts of user data (e.g., actions such as engagement, transactions, and/or the like) may be received by a system. In some situations, the system may process an event, or receipt of user data, using a data graph. However, based on particular business functions and/or needs, a company may require real-time analytics, decision-making, and customer engagement for particular events. Accordingly, the systems and/or techniques described herein may improve user experience and increase business efficiencies by personalizing user interactions in real time. Further, the use of real-time data graphs (e.g., a data graph accessed with low latency) that are tailored to real-time applications improve the utilization of computing resources by decreasing latency in processing user data in real time, while also requiring fewer instances of computing resources (e.g., CPU, GPU, RAM, etc.) for processing user data where real-time responses are not critical. Additionally, maintaining a data graph of the storage layer optimizes efficiencies in relating objects in a data cloud.

To address these and other technical problems and inefficiencies, the systems and/or techniques described herein may include a real-time layer (which may also be referred to as a “real-time component”) configured to process user data (e.g., user data requiring real-time interactions) using an instance of a data graph that is accessed through the real-time component with low latency, while also processing user data with an instance of the data graph at a storage layer (which may also be referred to as a “storage component.” The technical solutions discussed herein solve one or more technical problems associated with data processing which may negatively impact the user experience with high-latency processing, as well as inefficient use of computing resources.

In some examples, a system (e.g., a personalization system) may be supported by a data cloud service, or platform, including computing servers, data centers, and/or a cloud computing network. A data cloud service may be, or comprise, a data cloud provider network. A data cloud provider network (sometimes referred to simply as a “data cloud”) may refer to a pool of network-accessible computing resources (such as compute, storage, and networking resources, applications, and services), which may be virtualized or bare-metal. The data cloud can provide convenient, on-demand network access to a shared pool of configurable computing resources that can be programmatically provisioned and released in response to user commands. In other instances, however, a data cloud service may be an on-premises network, a private network of a corporation, and/or any other type of network or combination thereof.

The system may include one or more components configured to store and/or analyze data (e.g., a data warehouse, data lake, etc.). For example, the system may include one or more storage layers and/or platforms. The system may include a storage layer (e.g., a data warehouse, data lake, and/or a combination thereof (“a data lakehouse”)) and a low-latency storage layer (which may be referred to as a “a real-time layer”). Additionally, or alternatively, the system may be, or comprise, a service provider offering different built-in services to customers, users, etc. to help run their applications and services. For example, the system may include built-in services for computer applications such as a browser, application programming interface (API), software development kit (SDK), and/or the like.

The system may receive user data (e.g., an event). For example, the user data may be received by an SDK associated with the system. The user data may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data may be location data, voice data, financial data, and/or the like. For example, the user data may be, or comprise, a user action such as breaking a geofence, walking into a movie theatre, etc.

In some instances, the user data received by the system (e.g., via an SDK) may be sent to the real-time layer. The real-time layer may include one or more denormalized data graphs (hereinafter “real-time data graph”). A real-time data graph may correspond to a data graph of a storage layer that is accessed through the real-time layer with low latency. As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

When user data is received by the real-time layer, the system may be configured to generate and/or update one or more real-time data graphs. As described above, a real-time data graph may be a denormalized instance of a data graph (e.g., a denormalized JSON structure) such that data retrieval is optimized. As such, the system may process the user data, update the real-time data graph, and generate real-time personalization data in real time (e.g., in less than 500 milliseconds). By way of example, and not limitation, the real-time data layer may receive user data corresponding to a user action (e.g., engagement) with a website. A user action may include a signed-in user adding an item to their virtual shopping cart on a retailer website. Based on the user action, a real-time data graph of the real-time layer may be updated. For example, an existing real-time data graph may be defined by a Profile DMO and may include an email address field (e.g., the email address of the user). Additionally, or alternatively, the real-time data graph may further be defined by an Engagement DMO for engagement data related to a shopping cart. Accordingly, the real-time data graph may be updated to include an indication of the user adding the item to their virtual shopping cart. In some examples, the real-time layer may be configured to process and/or apply one or more transformations to the user data. For example, the real-time layer may be configured to unify user data (e.g., data at different devices, but from the same user), aggregate user data, classify users, and/or the like.

Based on the updated real-time data graph, the system may be configured to generate real-time personalization data. For example, real-time personalization data may comprise a user profile that has been updated in real-time. Continuing from the example above, based on the updated real-time data graph, the real-time personalization data may include an indication of previous context (e.g., the email address of the user) and the current (e.g., real-time) user data (e.g., adding the item to a shopping cart). Accordingly, based on the real-time personalization data, a user profile may include related attributes, or properties, of an individual (e.g., the user), an account, etc. Additionally, or alternatively, based on the real-time personalization data, a user profile may include properties enriched through processes such as aggregating the user data and/or classifying the user. The real-time personalization data may be available at a time that may be considered real time (e.g., within 500 milliseconds from the time of a user action).

The real-time personalization data may be usable, by the system and/or a third-party system, to generate an output. For example, an output may include a personalization at a web application, mobile application, etc. In some instances, the output may include a personalization at an application such as personalized text, decoration, user interface components, and/or the like. Additionally, or alternatively, the output may include a personalized communication. For example, a personalized communication may include an email, Short Message Service (SMS) message, and/or push notification. A personalized communication may include a personalized offer (e.g., discount), personalized reminder, etc. As described above, an updated real-time data graph may include an indication that a user added an item to their virtual shopping cart at a website, and personalization data (e.g., user profile) may be updated accordingly. Based on the personalization data, an output may be generated that is a personalized communication. By way of example, and not limitation, the personalized communication may be an email reminding the user that the item was added to their virtual shopping cart. This way, the system may be configured to decrease cart-abandonment rate. In some instances, the output may be displayed at a user device, such as at a user interface.

An output may be generated, displayed, and/or sent at a particular time. For example, the output may be generated at a time that may be considered real time (e.g., within 500 milliseconds from the time of the user action). Additionally, or alternatively, the output may be generated, displayed, and/or sent based on one or more triggers. For example, a trigger may include the termination of a user session. The termination of a user session may be the termination of a user event (e.g., end of a user action). By way of example, and not limitation, the termination of a user session may be based on a user disengagement (e.g., a user exists a browser), timeout restrictions (e.g., a lack of activity after a threshold period of time), and/or the like. Continuing from the example above, a personalized communication may include an email sent to remind a user that an item was added to their virtual shopping cart. Additionally, or alternatively, the sending of the personalized email may be based on a trigger such as the user exiting the browser without purchasing the item in their virtual shopping cart, and thus ending a session.

Additionally, or alternatively, the user data received by the system (e.g., via an SDK) may also be sent to a storage layer. The storage layer may include one or more data graphs. As described above, a data graph may include a hierarchical view of objects in a data cloud, and may be defined by a primary DMO as well as one or more fields, related DMOs, etc. When user data is received by the storage layer, the system may be configured to generate and/or update one or more data graphs of the storage layer. A data graph of the storage layer may be a denormalized instance of a data graph (e.g., denormalized JSON structure), and corresponding to the real-time data graph of the real-time layer. In other words, the storage layer and the real-time layer may each have an instance of the same data graph. While the storage layer may receive the same user data as the real-time layer, the storage layer may not be configured to process the user data, update the data graph, and generate personalization data in real-time. For example, the storage layer may use an instance of a data graph in order to optimize data consistency and reduce redundancy, as opposed to optimizing real-time querying. As such, the storage layer may not process the user data, update the data graph, and generate personalization data in real-time.

In some instances, the storage layer may be configured to receive additional user data and/or user data from other sources. For example, while the real-time layer may receive user data of an action such as website purchase activity, the storage layer may receive user data of an action such as a user purchasing an item in-person at a store, returning an item at the store, and/or the like. Additionally, or alternatively, while user data may be received from sources such as web sources, mobile sources, CRM sources, etc., the real-time layer may receive user data from a subset of the data sources, whereas the storage layer may receive user data from all of the sources.

Continuing from the example above, the storage layer may receive user data indicating a user action such as a user purchasing an item in-person at a store. Based on the user action, the data graph of the storage layer may be updated. For example, an existing data graph may be further defined by a DMO related to product purchasing. Accordingly, the data graph may be updated to include an indication of the user purchase, and/or an updated lifetime value (LTV) of spending. Additionally, or alternatively, the storage layer may be configured to process and/or apply one or more transformations to the user data. The storage layer may be configured to unify user data (e.g., data at different devices, but from the same user), aggregate user data, classify users, and/or the like. For example, the storage layer may, based on the updated LTV of spending, classify a user as belonging to a particular shopper status, and update the data graph accordingly.

Based on the updated data graph, the system may be configured to generate personalization data. For example, the personalization data may comprise a user profile that has been updated based on user data received by both the real-time layer and the storage layer, and/or additional data received by the storage layer. For example, based on the updated data graph, the personalization data may include an indication of purchases made by a user via a website application, as well as purchases made by the user in-person as part of an LTV of spending. Accordingly, based on the personalization data, a user profile may include related attributes, or properties, of an individual (e.g., the user), an account, etc. Additionally, or alternatively, based on the personalization data, a user profile may include properties enriched through processes such as aggregating the user data and/or classifying the user.

In some instances, the personalization data of the storage layer may replace the real-time personalization data of the real-time layer (e.g., the updated data graph may replace the updated real-time data graph). In other words, the personalization data of the storage layer may be considered the single source of truth. For example, the data graph of the storage layer and related personalization data may replace the real-time data graph and related real-time personalization data after the termination of a session (e.g., after the need for real-time response). This way, an updated data graph determined by the storage layer may be a final source of truth, where subsequent real-time processing by the real-time layer may be based on the updated data graph being accessed through the real-time layer with low latency. Additionally, or alternatively, the personalization data may be usable by the system and/or third-party system to generate the output described above and/or update the output.

As illustrated by these examples, the techniques described herein can improve the functioning, efficiency, and overall user experience during application engagement and/or use. That is, the techniques described herein may enable the system to use a real-time layer to quickly update a real-time data graph and generate real-time personalization data. Further, the techniques may result in increased processing speeds for generating outputs that benefit from real-time presentation. The techniques also enable relational efficiencies and data accuracy by enabling the system to use the storage layer and related components in conjunction with the real-time layer, rather than operating real-time applications on different data models than non-real-time applications.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized, and changes can be made without departing from the scope of the disclosure. The following detailed description is, therefore, not to be taken in a limiting sense. The scope of the disclosure is defined only by the appended claims, along with the full scope of equivalents to which such claims are entitled.

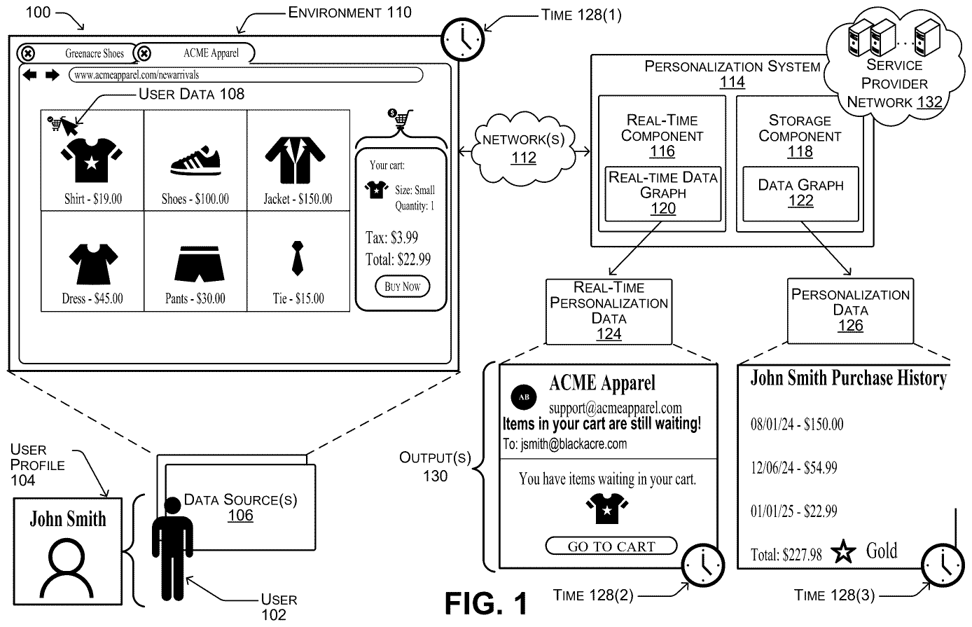

FIG. 1 illustrates a schematic view of an example system 100 for determining real-time personalization data using real-time data graphs.

In some examples, a personalization system 114 may be supported by a data cloud service, or platform, including computing servers, data centers, and/or a cloud computing network. A data cloud service may be, or comprise, a data cloud provider network (e.g., service provider network 132). The service provider network 132 may be or comprise a cloud provider network. A cloud provider network (sometimes referred to simply as a “data cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 132 may be an on-premises network, a private network of a corporation, and/or any other type of network or combination thereof.

The personalization system 114 may include one or more components configured to store and/or analyze data, such as real-time component 116 (e.g., a real-time layer) and storage component 118 (e.g., a storage layer). Additionally, or alternatively, the personalization system 114 may be, or comprise, a service provider offering different built-in services to customers, users, etc. to help run their applications and services. For example, the personalization system 114 may include built-in services for computer applications such as a browser, application programming interface (API), software development kit (SDK), and/or the like.

The user data 108 may be, or comprise, a user action at an environment 110, such as a user interface associated with a web application, mobile application, and/or the like. Additionally, or alternatively, the user data 108 may be received from data source(s) 106 such as web sources, mobile sources, CRM sources, etc. By way of example, and not limitation, a user action may include an engagement and/or interaction with an application (e.g., a user browsing a website, clicking on a product, logging in, etc.). In some instances, the environment 110 may be associated with one or more user devices. User devices may include one or more of different personal user devices, such as desktop computers, laptop computers, phones, tablets, wearable devices, entertainment devices such as televisions, and/or any other type of computing device. The environment 110 may be communicatively coupled with the personalization system 114 via network(s) 112, such as the Internet. In some instances, the network(s) 112 may generally comprise one or more networks implemented by any viable communication technology, such as wired and/or wireless modalities and/or technologies. The network(s) 112 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 112 may include devices, virtual resources, or other nodes that relay packets from one device to another.

The personalization system 114 may receive user data 108 (e.g., an event). For example, the user data 108 may be received by the real-time component 116 of the personalization system 114. The real-time component 116 may include one or more denormalized data graphs (hereinafter “real-time data graph 120”). When user data 108 is received by the real-time component 116, the personalization system 114 may be configured to generate and/or update real-time data graph 120. By way of example, and not limitation, the real-time data layer may receive user data 108 corresponding to a user action with a website (e.g., the user data 108 associated with environment 110). The user data 108 may include a signed-in user adding an item to their virtual shopping cart on a retailer website. Based on the user data 108, a real-time data graph 120 of the real-time component 116 may be updated. For example, an existing real-time data graph 120 may be defined by a Profile DMO and may include an email address field (e.g., the email address of the user). Additionally, or alternatively, the real-time data graph 120 may further be defined by an Engagement DMO for engagement data related to a shopping cart. Accordingly, the real-time data graph 120 may be updated to include an indication of the user adding the item to their virtual shopping cart.

Based on the updated real-time data graph 120, the personalization system 114 may be configured to generate real-time personalization data 124. For example, real-time personalization data 124 may comprise a user profile 104 that has been updated in real-time. Continuing from the example above, based on the updated real-time data graph 120, the real-time personalization data 124 may include an indication of previous context (e.g., the email address of the user 102) and the current (e.g., real-time) user data 108 (e.g., adding the item to a shopping cart). Accordingly, based on the real-time personalization data 124, a user profile 104 may include related attributes, or properties, of an individual (e.g., the user), an account, etc.

The real-time personalization data 124 may be usable, by the personalization system 114 and/or a third-party system, to generate output(s) 130. For example, an output 130 may include a personalization at a web application, mobile application, etc. Additionally, or alternatively, output 130 may include a personalized communication. For example, a personalized communication may include an email, Short Message Service (SMS) message, and/or push notification. As described above, an updated real-time data graph 120 may include an indication that the user 102 added an item to their virtual shopping cart at a website, and real-time personalization data 124 (e.g., user profile 104) may be updated accordingly. Based on the real-time personalization data 124, an output 130 may be generated that is a personalized communication of an email reminding the user that the item was added to their virtual shopping cart. In some instances, the output 130 may be displayed at a user device, such as at a user interface (e.g., environment 110). An output 130 may be generated, displayed, and/or sent at a particular time, such as time 128(2). For example, the output 130 may be generated at time 128(2) that may be considered real time (e.g., within 500 milliseconds from the time 128(1) of the user data 108).

Additionally, or alternatively, the user data 108 received by the personalization system 114 may also be sent to a storage component 118. The storage component 118 may include one or more denormalized data graphs (e.g., data graph 122). As described above, a data graph may include a hierarchical view of objects in a data cloud, and may be defined by a primary DMO as well as one or more fields, related DMOs, etc. When user data 108 is received by the storage component 118, the personalization system 114 may be configured to generate and/or update the data graph 122. While the storage component 118 may receive the same user data 108 as the real-time component 116, the storage component 118 may not be configured to process the user data 108, update the data graph 122, and generate personalization data 126 in real-time (e.g., at time 128(2)). Instead, the storage component 118 may process the user data 108, update the data graph 122, and/or generate personalization data 126 at time 128(3), such as the termination of a user session.

Based on the updated data graph 122, the personalization system 114 may be configured to generate personalization data 126. For example, the personalization data 126 may comprise a user profile 104 that has been updated based on user data 108 received by both the real-time component 116 and the storage component 118, and/or additional data received by the storage component 118. For example, based on the updated data graph 122, the personalization data 126 may include an indication of purchases made by the user 102 via a website application, as well as purchases made by the user 102 in-person. Additionally, or alternatively, the personalization data 126 may also be usable to generate output(s) 130. For example, based on the personalization data 126 (e.g., indicating total spending by the user 102), and output 130 may be generated that is a user interface component indicating that the user 102 has reached a spending tier (e.g., a “gold” tier). An output 130 may be generated, displayed, and/or sent at a particular time, such as time 128(3). For example, the output 130 may be generated at time 128(3), such as when a user session has terminated.

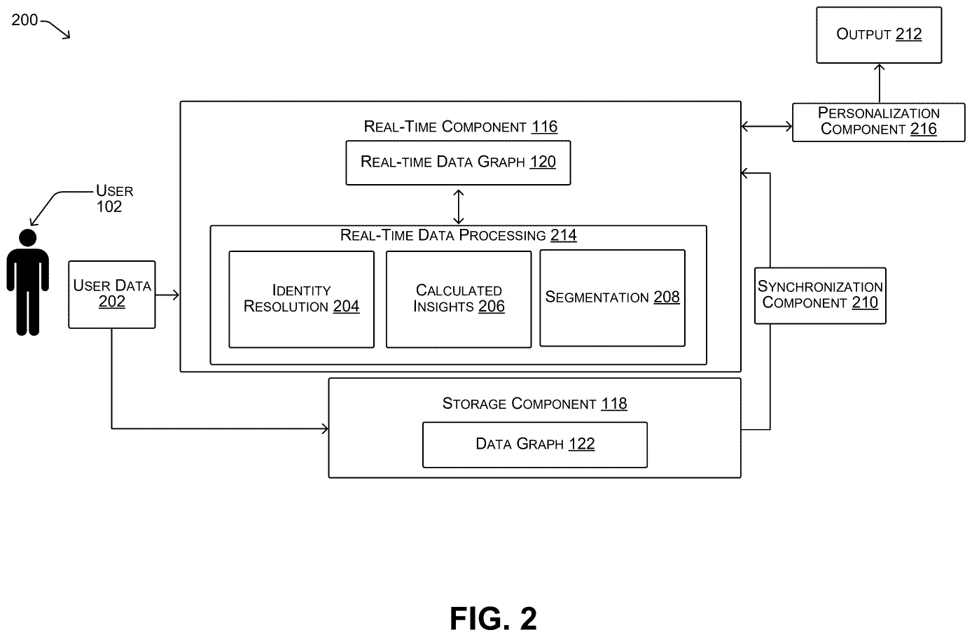

FIG. 2 illustrates a system-architecture diagram of an example system 200 in which a system uses real-time data graphs.

The system 200 may include one or more components configured to store and/or analyze data (e.g., a data warehouse, data lake, etc.). For example, the system may include one or more storage layers and/or platforms. The system may include a storage layer (e.g., a data warehouse, data lake, and/or a combination thereof (“a data lakehouse”)) and a low-latency storage layer (which may be referred to as a “a real-time layer”). For example, the storage layer may correspond to storage component 118, and the low-latency storage layer may correspond to real-time component 116.

As illustrated, user data 202 from a user 102 may be received by the system, and at the real-time component 116 and the storage component 118. The real-time component 116 may include one or more denormalized data graphs (e.g., real-time data graph 120). As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

When user data 202 is received by the real-time layer, the system may be configured to generate and/or update one or more real-time data graphs, such as real-time data graph 120. Before the user data 202 is updated into the real-time data graph 120, the real-time component 116 may be configured to process and/or apply one or more transformations to the user data 202. For example, real-time processing 214 may include identity resolution 204, calculated insights 206, and/or segmentation 208. Identity resolution 204 may be configured to unify user data (e.g., data at different devices, but from the same user). For example, based on the user data 202, identity resolution 204 may match different user identities, or user profiles, into a unified identity (e.g., unified data graph). Identity resolution 204 may be based on one or more rules. For example, user identities may be unified if there is a match between user emails. Calculated insights 206 may be configured to perform one or more computations with respect to the user data 202, such as aggregating and/or counting metrics. For example, calculated insights 206 may be configured to determine an aggregation of all browsing performed by the user 102, total spending (e.g., LTV) of the user 102, and/or the like. Aggregations by calculated insights 206 may be available in real time and reflected in the real-time data graph 120. Segmentation 208 may be configured to classify, or segment, a user 102. For example, an organization may define one or more segments on the real-time data graph 120. A segment may be based on any element of the data graph 120 (e.g., a segment based on browsing behavior, product purchasing, etc.) and/or aggregations by calculated insights 206 (e.g., a segment based on total spending of the user 102). One or more segments associated with a user 102 and determined by segmentation 208 may be available in real time and reflected in the updated real-time data graph 120. Subsequent to real-time data processing 214, and based on an updated real-time data graph 120, the real-time component 116 may be configured to generate real-time personalization data. The real-time personalization data may be usable by a personalization component 216 to generate an output 212.

As described above, the user data 202 may also be received by the storage component 118. The storage component 118 may include one or more data graphs (e.g., data graph 122). Data graph 122 may be a denormalized instance of a data graph (e.g., denormalized JSON structure), and corresponding to the real-time data graph 120 of the real-time component 116. In some instances, the storage component 118 may be configured to receive additional user data and/or user data from other sources. Additionally, or alternatively, while user data 202 may be received from sources such as web sources, mobile sources, CRM sources, etc., the real-time component 116 may receive user data from a subset of the data sources, whereas the storage component 118 may receive user data from all of the sources. Before user data 202 is updated into the data graph 122, the storage component 118 may be configured to apply one or more transformations to the user data 202. While not illustrated, the storage component 118 may similarly perform processing such as identity resolution 204, calculated insights 206, and/or segmentation 208. Once user data 202 has been updated into the data graph 122, the updated data graph 122 may be used by the storage component to generate personalization data. For example, the personalization data may comprise a user profile that has been updated based on user data 202 received by both the real-time component 116 and the storage component 118, and/or additional data received by the storage layer.

In some instances, a synchronization component 210 of the system 200 may be configured to replace the real-time personalization data of the real-time component 116 with the personalization data of the storage component 118 (e.g., the updated data graph 122 may replace the updated real-time data graph 120). In other words, the personalization data of the storage component 118 may be considered the single source of truth. For example, the data graph 122 of the storage component 118 and related personalization data may replace the real-time data graph 120 and related real-time personalization data after the termination of a session (e.g., after the need for real-time response). This way, subsequent real-time processing 214 by the real-time component 116 may be based on the updated data graph 122 determined by the storage component 118, as opposed to the updated real-time data graph 120 previously-determined by the real-time component 116. Additionally, or alternatively, the personalization data may be usable by the personalization component 216 to generate the output 212 described above and/or update the output 212.

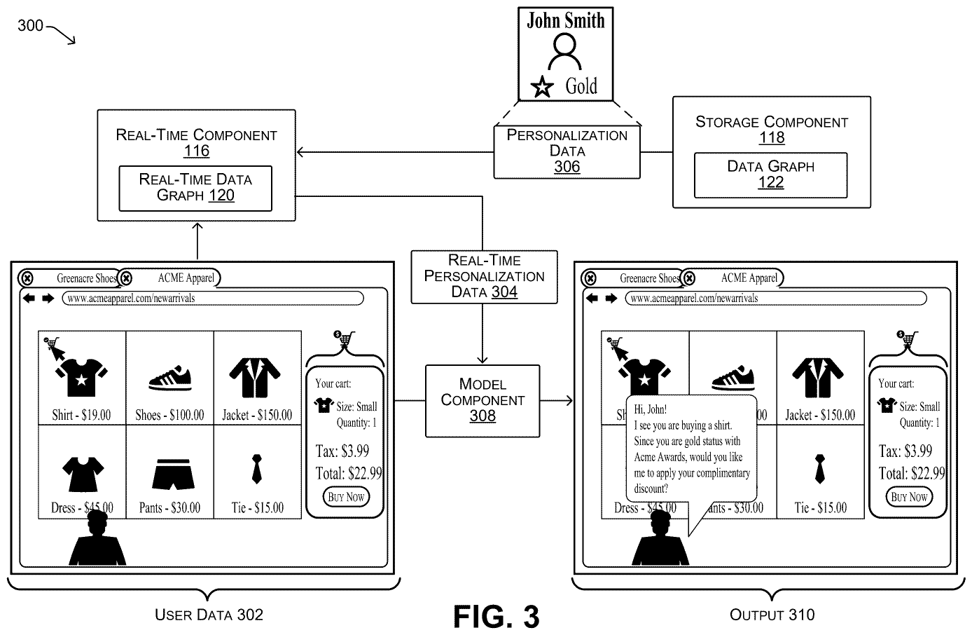

FIG. 3 illustrates a block diagram including an example process 300 for the use of real-time data graphs by a generative machine learned model, and related user interfaces.

A system (e.g., personalization system 114) may receive user data 302, which may comprise a user action at a web application, mobile application, and/or the like. The data 302 may be received at a real-time component 116. When user data 302 is received by the real-time component 116, the system may be configured to generate and/or update the real-time data graph 120. As described above, the real-time data graph 120 may be a denormalized data graph. For example, the real-time data graph 120 may correspond to a denormalized instance of the data graph 122 generated and/or updated by the storage component 118. In some instances, the data graph 122 generated and/or updated by the storage component 118 may indicate personalization data 306. For example, the storage component 118 may have previously (e.g., not in real-time) received user data, and updated the data graph 122 accordingly, where the updated data graph 122 indicates personalization data 306 such as a user being associated with a “gold status” (e.g., a segment). As such, the real-time data graph 120 of the real-time component 116 may include the indication of the user “gold status” at the start of a session (e.g., when user data 302 is received by the real-time component 116). As illustrated, the user data 302 may include a user action such as a user adding an item to a virtual cart. Based on the user data 302, the real-time component may update the real-time data graph 120, which may be used to generate real-time personalization data 304. The real-time personalization data 304 may comprise a user profile that has been updated in real-time, and may include related attributes, or properties, of an individual (e.g., the user), an account, etc. For example, the real-time personalization data 304 may include an indication of the user's “gold status,” as well as the real-time data of the user adding an item to their virtual cart. In other words, the real-time personalization data 304 includes both prior context and real-time data.

The real-time personalization data 304 may be usable to generate an output 310. For example, an output 310 may include a personalization at a web application, mobile application, etc. In some instances, the output may include a personalization at an application such as personalized text, decoration, user interface components, and/or the like. A personalized communication may include a personalized offer (e.g., discount), personalized reminder, etc. The system may use, or work in combination with, a model component 308 to generate the output 310. The model component 308 may comprise one or more machine-learning models. For example, the machine-learning models as described herein may include predictive analytic techniques, which may include, for example, predictive modelling, machine-learning, and/or data mining. Generally, predictive modelling may utilize statistics to predict outcomes. Machine-learning, while also utilizing statistical techniques, may provide the ability to improve outcome prediction performance without being explicitly programmed to do so. A number of machine-learning techniques may be employed to generate and/or modify the models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine-learning. In some examples, the real-time personalization data 304 may be usable by the model component 308 in order to generate an output 310, such as a personalization at a user interface of a chat bot configured to digitally engage with users either by voice or text communications. For example, the model component 308 may comprise a generative machine-learning model, such as a large language model (LLM). For example, based on the real-time personalization data, the model component 308 may be configured to generate the output 310 including a chat bot engaging with a user via a user interface, such as “I see you are buying a shirt. Since you are a gold status with Acme Awards, would you like me to apply your complimentary discount?”

In various implementations, the models and/or modules described herein (e.g., including, but not limited to the model component 308, or other components or systems discussed herein) may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be incorporated into a framework of an existing system. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG), an iterative process, or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. In some examples, the AI technologies may be used to implement one or more iterative process(es). Furthermore, the AI technologies may be merged in a variety of implementations, for example, by bagging, boosting, stacking, etc. the AI technologies.

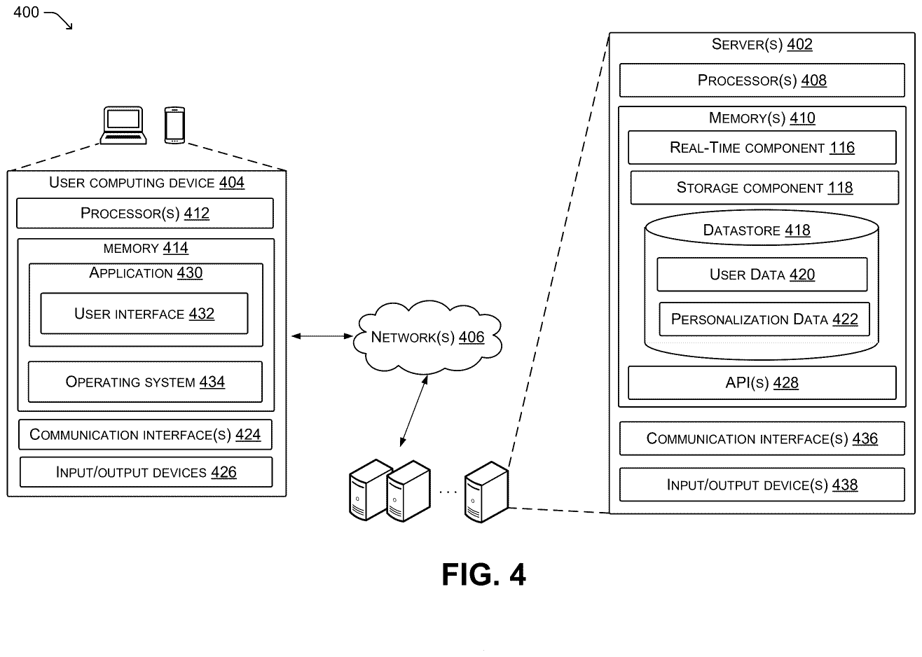

FIG. 4 illustrates an example environment 400 for performing the techniques described herein. The techniques discussed herein may be used in a variety of environments and for a variety of uses, although the examples given herein discuss a customer service environment as one of these use cases since it's a use case familiar to many. In additional or alternate examples, the computing environment may comprise computing devices used for sales-based systems, communication platforms, chat engines, cybersecurity, search engines, multi-agent/agentic machine-learned model pipeline(s) and/or cluster(s), machine-learned model training, cloud/distributed computing or massive computing efficient data storage and/or retrieval, and/or the like.

In at least one example, the example environment 400 may include one or more computing devices, such as server(s) 402 and/or a user computing device(s) 404. By way of example and not limitation, the server(s) 402 may be representative of servers for hosting the software, hardware, containers, and/or the like to implement at least part of the techniques discussed herein. For example, the server(s) 402 may host (e.g., store and/or execute) system software. The user computing device(s) 404 may be representative of user computing device(s) associated with a first user (i.e., a first “client device”).

The server(s) 402 may comprise one or more individual servers or other computing devices that may be physically located in a single central location or may be distributed at multiple different locations. The server(s) 402 communication may be hosted privately by an entity administering all or part of the environment 400 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures may be used. Moreover, the server(s) 402 may comprise hardware and/or software containers accessible to different tenants with access to the server(s) 402.

The user computing device(s) 404 may be any suitable type of computing device, e.g., portable, semi-portable, semi-stationary, or stationary. Some examples of the user computing device(s) 404 may include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the user computing device(s) 404 may comprise distributed computing devices, server(s), etc.

In some examples, the server(s) 402 and/or user computing device(s) 404 may be configured to transmit network packages therebetween via network(s) 406. The network(s) 406 may include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network,, or any other such network, or any combination thereof. The network(s) 406 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the user computing device(s) 404 may transmit a request to and/receive an output from the server(s) 402 via the communication platform. Components used for such communications can depend at least in part upon the type of network, the environment selected, or both. Further, the network(s) 406 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

The server(s) 402 and the user computing device(s) 404 described herein may include one or more processors and/or memory. Specifically, in the illustrated example, server(s) 402 may include processor(s) 408 and memory 410 and user computing device(s) 404 include processor(s) 412 and memory 414.

By way of example and not limitation, the processor(s) 408 and/or 412 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions. For example, the processor(s) 408 and/or 412 can be one or more hardware processors and/or logic circuits of any suitable type specifically programmed or configured to execute the algorithms and processes described herein. The processor(s) 408 and/or 412 can be configured to fetch and execute computer-readable instructions stored in the computer-readable media, which can program the processor(s) to perform the functions described herein.

The memory 410 and/or 414 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 410 and/or 414 can be used to store any number of software/functional components that are executable by the processor(s) 408 and/or 412, respectively. In many implementations, these functional components comprise instructions or programs that are executable by the processor(s) 408 and/or 412 and that, when executed, specifically configure the processor(s) 408 and/or 412 to perform the actions server(s) 402 and/or user computing device(s) 404, according to the discussion herein.

For example, server(s) 402 may comprise a memory 410 storing the real-time component 116 and storage component 118. As described throughout, the real-time component 116 and/or storage component 118 may leverage data graphs to determine real-time personalization and personalization data, respectively. In some examples, the system may receive user data including a user action (e.g., browsing a webpage, clicking a user interface component, etc.). The system may leverage the real-time component 116 such that a real-time data graph may be generated and/or updated based on the user action. Accordingly, the system may use the real-time data graph to generate personalization data. When generating personalization data, the real-time component 116 may update and/or create a user profile, where the user profile may indicate attributes, actions, and/or the like associated with a user. The real-time component 116 may determine personalization data at a time at which the personalization data may be accessed and/or used in real-time. The system may also leverage the storage component 118, where the storage component 118 may include a data graph. The storage layer may also receive the user data, and/or other data. The system may leverage the storage component 118 such that a data graph may be generated and/or updated based on the user action and/or other actions (e.g., non-real-time actions). The system may use the data graph to also generate personalization data. For example, the personalization data generated using the data graph of the storage component 118 may be used by the system to further update the user profile. The personalization data generated using the data graph of the storage component 118 may be determined at a time at which the personalization data may be accessed and/or used at a subsequent time (e.g., not real-time). Additionally, or alternatively, personalization data may be used to generate one or more personalized outputs for a user.

Additionally, or alternatively, the memory 410 may comprise a portion of memory 410 (e.g., one or more memories or a portion of a single memory) that collectively forms a datastore 418 (e.g., a database). In some examples, the datastore 418 can be integrated with the server(s) 402, as shown in FIG. 4. In other examples, the datastore 418 can be located remotely from the server(s) 402 and can be accessible to the server(s) 402 and/or user device(s), such as the user computing device(s) 404. The datastore 418 can comprise multiple databases, which may include user data 420 and/or personalization data 422. Additional or alternative data may be stored in the data store and/or one or more other data stores.

In at least one example, the user data 420 may correspond to user data 108, 202, and/or user data 302. As described above, the user data 420 may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data 420 may be location data, voice data, financial data, and/or the like. For example, the user data 420 may be, or comprise, a user action such as breaking a geofence, walking into a movie theatre, etc.

In at least one example, personalization data 422 may correspond to real-time personalization data 124, personalization data 126, real-time personalization data 304, and/or personalization data 306. As described above, personalization data 422 may include a user profile that has been updated in real-time, at a time subsequent to a user session, etc. For example, based on the updated real-time data graph, personalization data 422 may include an indication of previous context (e.g., the email address of the user) and the current (e.g., real-time) user data (e.g., adding the item to a shopping cart). Personalization data 422 may include related attributes, or properties, of an individual (e.g., the user), an account, etc. associated with a user profile.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

Additionally, or alternatively, the memory 410 may store application programming interface(s) (API(s) 428), hypervisor(s), container orchestration system(s), an operating system, and/or container (unillustrated). The API(s) 428 may expose back-end functions and/or services hosted by the server(s) 402 to the user computing device(s) 404 and/or different component(s) hosted by the server(s) 402 without transferring the functions/services/software to those computing device(s) and/or by accomplishing the functions and/or services at the server(s) 402. As relates to the instant discussion, this may comprise API(s) for receiving indications from a user (e.g., as part of an API call), or from different ones of the components.

In some examples, software executed at the user computing device(s) 404, such as a client application 430, may generate API call(s) to the API(s) 428 and/or any of the component(s) discussed herein may transmit call(s) to the API(s) 428 and/or receive responses from the API(s) 428. For example, a user interface 432 executed by a client application 430 may display actuatable/selectable options to request that the client application 430 perform an action. In some examples, the client application 430 may interface with the API(s) 428 to authenticate a user and grant or deny the user access to a portion of the datastore 418, real-time component 116, and/or storage component 118.

Additionally, or alternatively, the memory 410 may comprise an operating system and/or container. In some examples, one or more containers may be instantiated by a cloud orchestrator and may run the operating system and may execute one or more instances of the API(s) 428, real-time component 116, and/or storage component 118, and may permit access to a portion of the datastore 418 according to permissions associated with a user and an organization associated with the container.

In some examples, the server(s) 402 may further comprise communication interface(s) 436, which may include one or more interfaces and hardware components for enabling communication with various other devices (e.g., the user computing device(s) 404), such as over the network(s) 406 or directly. In some examples, the communication interface(s) 436 can facilitate communication via WebSockets, APIs (e.g., using API calls), Hypertext Transfer Protocols (HTTPs), etc. The server(s) 402 can further be equipped with various input/output devices 438 (e.g., I/O devices). Such input/output devices 438 may include a display, various user interface controls (e.g., buttons, joystick, keyboard, mouse, touch screen, etc.), audio speakers, connection ports, and so forth.

In at least one example, the user computing device(s) 404 may include processor(s) 412, memory 414, communication interface(s) 424, and/or input/output device(s) 426. The memory 410 may store and execute a client application 430 and/or an operating system 434. In some examples, the client application 430 may be configured to authenticate a user to access data and/or services hosted by the server(s) 402. The API(s) 428 may filter the users and/or orgs accessible depending on permissions granted to a type of user profile and/or an organization associated with the user. In at least one example, a user profile to which a user authenticates may include permission data associated with permissions of individual users of the platform. In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the platform by maintaining security for limiting access to a defined group of users. In some examples, such users can be defined by common access credentials, group identifiers, or the like, as described above.

In some examples, the client application 430 may comprise instructions executable by one or more processors to provide a user interface 432. For example, the user interface 432 may comprise a graphical user interface (GUI), that the instructions may cause to be displayed via at least one of the input/output device(s) 426. In at least one example, the client application 430 can be a mobile application, a web application, a database interface (e.g., such as an application that presents a SQL or other database interface), or a desktop application. For example, a computing device of the one or more user computing device(s) 404 may access the API(s) 428 via a web browser or stand-alone application (either of which may be part of or host the client application 430) that communicates via network(s) 406 with API(s) 428.

In at least one example, the operating system 434 can manage the processor(s) 408, memory 410, hardware, software, etc. of the server(s) 402.

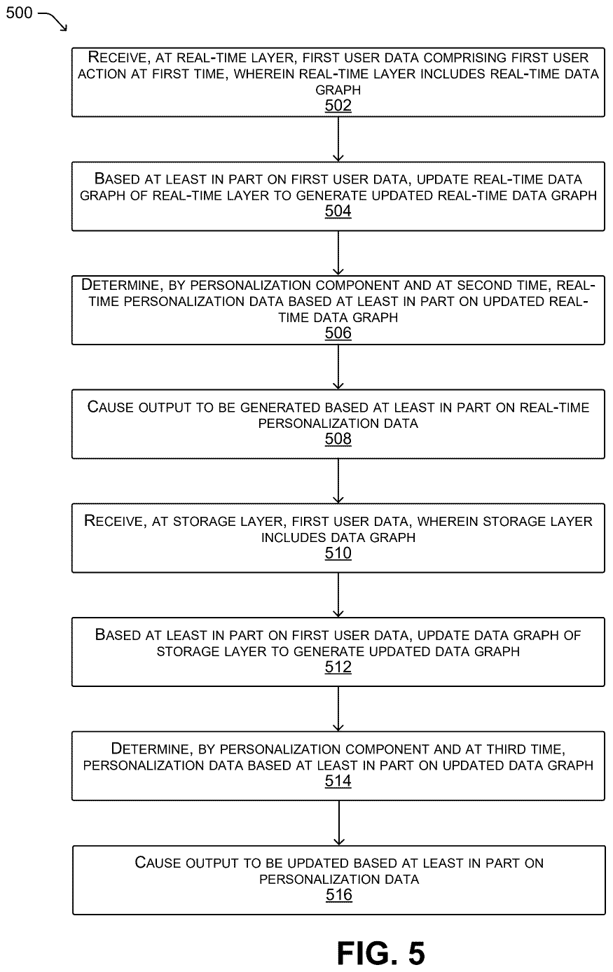

FIG. 5 is a flow diagram illustrating an example process of determining personalized data using real-time data graphs. The processes illustrated in FIG. 5 are described with reference to components described above with reference to FIGS. 1-4 for convenience and ease of understanding. However, the processes illustrated in FIG. 5 are not limited to being performed using the components described above. Moreover, the components described above are not limited to performing the processes illustrated in FIG. 5.

Process 500 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 502, the process 500 may include receiving, at a real-time layer, first user data comprising a first user action at a first time, wherein the real-time layer includes a real-time data graph. For example, a system may include one or more components configured to store and/or analyze data (e.g., a data warehouse, data lake, etc.). For example, the system may include one or more storage layers and/or platforms. The system may include a storage layer (e.g., a data warehouse, data lake, and/or a combination thereof (“a data lakehouse”)) and a low-latency storage layer (which may be referred to as a “a real-time layer”). Additionally, or alternatively, the system may be, or comprise, a service provider offering different built-in services to customers, users, etc. to help run their applications and services. For example, the system may include built-in services for computer applications such as a browser, application programming interface (API), software development kit (SDK), and/or the like.

The system may receive user data (e.g., an event). For example, the user data may be received by an SDK associated with the system. The user data may be, or comprise, a user action at a web application, mobile application, and/or the like. By way of example, and not limitation, a user action may include an engagement and/or interaction with an application (e.g., a user browsing a website, clicking on a product, logging in, etc.). Additionally, or alternatively, user data may be location data, voice data, financial data, and/or the like. For example, the user data may be, or comprise, a user action such as breaking a geofence, walking into a movie theatre, etc.

In some instances, the user data received by the system (e.g., via an SDK) may be sent to the real-time layer. The real-time layer may include one or more denormalized data graphs (hereinafter “real-time data graph”). As used herein, a data graph may include a hierarchical view of objects in a data cloud. For example, a data graph may be defined by, or based on, a primary data model object (DMO). By way of example, and not limitation, a primary DMO may be a Profile DMO, and indicate that personalized experiences are to be based on a user, or user profile. In other words, a primary DMO may indicate a data cloud object that is of interest to an application, company, etc. From the primary DMO, one or more fields and/or related DMOs may be defined. For example, data fields may include purchases associated with the Profile DMO, browsing behavior associated with the Profile DMO, and/or the like. Related DMOs to a primary DMO may include other Profile DMOs, a Device DMO (e.g., a specific device to track signals from), an Engagement DMO (e.g., engagement data related to email, product browsing, product purchasing, shopping cart, website, web search, and/or the like), etc.

At operation 504, the process 500 may include, based at least in part on the first user data, updating the real-time data graph of the real-time layer to generate an updated real-time data graph. For example, when user data is received by the real-time layer, the system may be configured to generate and/or update one or more real-time data graphs. As described above, a real-time data graph may be a denormalized instance of a data graph (e.g., a denormalized JSON structure) such that data retrieval is optimized. As such, the system may process the user data, update the real-time data graph, and generate real-time personalization data in real time (e.g., in less than 500 milliseconds). By way of example, and not limitation, the real-time data layer may receive user data corresponding to a user action (e.g., engagement) with a website. A user action may include a signed-in user adding an item to their virtual shopping cart on a retailer website. Based on the user action, a real-time data graph of the real-time layer may be updated. For example, an existing real-time data graph may be defined by a Profile DMO and may include an email address field (e.g., the email address of the user). Additionally, or alternatively, the real-time data graph may further be defined by an Engagement DMO for engagement data related to a shopping cart. Accordingly, the real-time data graph may be updated to include an indication of the user adding the item to their virtual shopping cart. In some examples, the real-time layer may be configured to process and/or apply one or more transformations to the user data. For example, the real-time layer may be configured to unify user data (e.g., data at different devices, but from the same user), aggregate user data, classify users, and/or the like.

At operation 506, the process 500 may include determining, by a personalization component and at a second time, real-time personalization data based at least in part on the updated real-time data graph. For example, based on the updated real-time data graph, the system may be configured to generate real-time personalization data. For example, real-time personalization data may comprise a user profile that has been updated in real-time. Continuing from the example above, based on the updated real-time data graph, the real-time personalization data may include an indication of previous context (e.g., the email address of the user) and the current (e.g., real-time) user data (e.g., adding the item to a shopping cart). Accordingly, based on the real-time personalization data, a user profile may include related attributes, or properties, of an individual (e.g., the user), an account, etc. Additionally, or alternatively, based on the real-time personalization data, a user profile may include properties enriched through processes such as aggregating the user data and/or classifying the user. The real-time personalization data may be available at a time that may be considered real time (e.g., within 500 milliseconds from the time of a user action).

At operation 508, the process 500 may include causing an output based at least in part on the real-time personalization data to be generated. For example, real-time personalization data may be usable, by the system and/or a third-party system, to generate an output. For example, an output may include a personalization at a web application, mobile application, etc. In some instances, the output may include a personalization at an application such as personalized text, decoration, user interface components, and/or the like. Additionally, or alternatively, the output may include a personalized communication. For example, a personalized communication may include an email, Short Message Service (SMS) message, and/or push notification. A personalized communication may include a personalized offer (e.g., discount), personalized reminder, etc. As described above, an updated real-time data graph may include an indication that a user added an item to their virtual shopping cart at a website, and personalization data (e.g., user profile) may be updated accordingly. Based on the personalization data, an output may be generated that is a personalized communication. By way of example, and not limitation, the personalized communication may be an email reminding the user that the item was added to their virtual shopping cart. This way, the system may be configured to decrease cart-abandonment rate. In some instances, the output may be displayed at a user device, such as at a user interface.

An output may be generated, displayed, and/or sent at a particular time. For example, the output may be generated at a time that may be considered real time (e.g., within 500 milliseconds from the time of the user action). Additionally, or alternatively, the output may be generated, displayed, and/or sent based on one or more triggers. For example, a trigger may include the termination of a user session. The termination of a user session may be the termination of a user event (e.g., end of a user action). By way of example, and not limitation, the termination of a user session may be based on a user disengagement (e.g., a user exists a browser), timeout restrictions (e.g., a lack of activity after a threshold period of time), and/or the like. Continuing from the example above, a personalized communication may include an email sent to remind a user that an item was added to their virtual shopping cart. Additionally, or alternatively, the sending of the personalized email may be based on a trigger such as the user exiting the browser without purchasing the item in their virtual shopping cart, and thus ending a session.

At operation 510, the process 500 may include receiving, at a storage layer, the first user data, wherein the storage layer includes a data graph. For example, the user data received by the system (e.g., via an SDK) may also be sent to a storage layer. The storage layer may include one or more data graphs. As described above, a data graph may include a hierarchical view of objects in a data cloud, and may be defined by a primary DMO as well as one or more fields, related DMOs, etc. When user data is received by the storage layer, the system may be configured to generate and/or update one or more data graphs of the storage layer. A data graph of the storage layer may be a denormalized instance of a data graph (e.g., denormalized JSON structure), and corresponding to the real-time data graph of the real-time layer. In other words, the storage layer and the real-time layer may each have an instance of the same data graph. While the storage layer may receive the same user data as the real-time layer, the storage layer may not be configured to process the user data, update the data graph, and generate personalization data in real-time. For example, the storage layer may use an instance of a data graph in order to optimize data consistency and reduce redundancy, as opposed to optimizing real-time querying. As such, the storage layer may not process the user data, update the data graph, and generate personalization data in real-time.

In some instances, the storage layer may be configured to receive additional user data and/or user data from other sources. For example, while the real-time layer may receive user data of an action such as website purchase activity, the storage layer may receive user data of an action such as a user purchasing an item in-person at a store, returning an item at the store, and/or the like. Additionally, or alternatively, while user data may be received from sources such as web sources, mobile sources, CRM sources, etc., the real-time layer may receive user data from a subset of the data sources, whereas the storage layer may receive user data from all of the sources.

At operation 512, the process 500 may include, based at least in part on the first user data, updating the data graph of the storage layer to generate an updated data graph. Continuing from the example above, the storage layer may receive user data indicating a user action such as a user purchasing an item in-person at a store. Based on the user action, the data graph of the storage layer may be updated. For example, an existing data graph may be further defined by a DMO related to product purchasing. Accordingly, the data graph may be updated to include an indication of the user purchase, and/or an updated lifetime value (LTV) of spending. Additionally, or alternatively, the storage layer may be configured to process and/or apply one or more transformations to the user data. The storage layer may be configured to unify user data (e.g., data at different devices, but from the same user), aggregate user data, classify users, and/or the like. For example, the storage layer may, based on the updated LTV of spending, classify a user as belonging to a particular shopper status, and update the data graph accordingly.

At operation 514, the process 500 may include determining, by the personalization component and at a third time, personalization data based at least in part on the updated data graph. For example, based on the updated data graph, the system may be configured to generate personalization data. For example, the personalization data may comprise a user profile that has been updated based on user data received by both the real-time layer and the storage layer, and/or additional data received by the storage layer. For example, based on the updated data graph, the personalization data may include an indication of purchases made by a user via a website application, as well as purchases made by the user in-person as part of an LTV of spending. Accordingly, based on the personalization data, a user profile may include related attributes, or properties, of an individual (e.g., the user), an account, etc. Additionally, or alternatively, based on the personalization data, a user profile may include properties enriched through processes such as aggregating the user data and/or classifying the user.

At operation 516, the process 500, the process may include causing the output to be updated based at least in part on the personalization data. For example, the personalization data of the storage layer may replace the real-time personalization data of the real-time layer (e.g., the updated data graph may replace the updated real-time data graph). In other words, the personalization data of the storage layer may be considered the single source of truth. For example, the data graph of the storage layer and related personalization data may replace the real-time data graph and related real-time personalization data after the termination of a session (e.g., after the need for real-time response). This way, subsequent real-time processing by the real-time layer may be based on the updated data graph determined by the storage layer, as opposed to the updated real-time data graph previously-determined by the real-time layer. Additionally, or alternatively, the personalization data may be usable by the system and/or third-party system to generate the output described above and/or update the output.

### Example Clauses

A. A system comprising: one or more processors; and one or more non-transitory computer-readable media storing computer-executable instructions that, when executed, cause the one or more processors to perform operations comprising: receiving, at a real-time layer, first user data comprising a first user action at a first time, wherein the real-time layer includes a real-time data graph; based at least in part on the first user data, updating the real-time data graph of the real-time layer to generate an updated real-time data graph; determining, by a personalization component and at a second time, real-time personalization data based at least in part on the updated real-time data graph; causing an output to be generated based at least in part on the real-time personalization data; receiving, at a storage layer, the first user data, wherein the storage layer includes a data graph; based at least in part on the first user data, updating the data graph of the storage layer to generate an updated data graph; determining, by the personalization component and at a third time, personalization data based at least in part on the updated data graph; and causing the output to be updated based at least in part on the personalization data.

B. The system of paragraph A, wherein the real-time data graph is based on a data model object (DMO).

C. The system of paragraph B, wherein the DMO is based on one or more data fields, the one or more data fields comprising one of: an email address; a phone number; a date; a time; or a Uniform Resource Locator (URL).

D. The system of paragraph A, wherein the real-time personalization data is first real-time personalization data, the updated data graph is a first updated data graph, and the output is a first output, the operations further comprising: receiving, at the real-time layer, second user data comprising a second user action at a fourth time; based at least in part on the second user data, updating the first updated real-time data graph to generate a second updated real-time data graph; determining, by a model component and at the fourth time, second real-time personalization data based at least in part on the second updated real-time data graph; causing a second output to be generated based at least in part on the second real-time personalization data; and causing display of an indication of the second output at a user interface associated with the model component.

E. The system of paragraph A, wherein the personalization data is first personalization data, and the updated data graph is a first updated data graph, the operations further comprising: receiving, at the storage layer, second user data comprising a second user action at a fourth time; based at least in part on the second user data, updating the first updated data graph to generate a second updated data graph; determining, by the personalization component and at a fourth time, second personalization data based at least in part on the second updated data graph; and causing the output to be updated based at least in part on the second personalization data.

F. The system of paragraph A, wherein the output includes user profile data, user profile data comprising one of: a user identification; user browsing history; user purchase history; or user category.

G. The system of paragraph A, wherein: the first user data is received from one of a first subset of data sources; and the second user data is received from one of the first subset of data sources or a second subset of data sources.

H. One or more non transitory computer readable media storing instructions executable by one or more processors, wherein the instructions, when executed, cause the one or more processors to perform operations comprising: receiving, at a real-time layer, first user data comprising a first user action at a first time, wherein the real-time layer includes a real-time data graph; based at least in part on the first user data, updating the real-time data graph of the real-time layer to generate an updated real-time data graph; determining, by a personalization component and at a second time, real-time personalization data based at least in part on the updated real-time data graph; causing an output to be generated based at least in part on the real-time personalization data; receiving, at a storage layer, the first user data, wherein the storage layer includes a data graph; based at least in part on the first user data, updating the data graph of the storage layer to generate an updated data graph; determining, by the personalization component and at a third time, personalization data based at least in part on the updated data graph; and causing the output to be updated based at least in part on the personalization data.

I. The one or more non transitory computer readable media of paragraph H, wherein the real-time data graph is based on a data model object (DMO).

J. The one or more non transitory computer readable media of paragraph I, wherein the DMO is based on one or more data fields, the one or more data fields comprising one of: an email address; a phone number; a date; a time; or a Uniform Resource Locator (URL).

K. The one or more non transitory computer readable media of paragraph H, wherein the real-time personalization data is first real-time personalization data, the updated data graph is a first updated data graph, and the output is a first output, the operations further comprising: receiving, at the real-time layer, second user data comprising a second user action at a fourth time; based at least in part on the second user data, updating the first updated real-time data graph to generate a second updated real-time data graph; determining, by a model component and at the fourth time, second real-time personalization data based at least in part on the second updated real-time data graph; causing a second output to be generated based at least in part on the second real-time personalization data; and causing display of an indication of the second output at a user interface associated with the model component.

L. The one or more non transitory computer readable media of paragraph H, wherein the personalization data is first personalization data, and the updated data graph is a first updated data graph, the operations further comprising: receiving, at the storage layer, second user data comprising a second user action at a fourth time; based at least in part on the second user data, updating the first updated data graph to generate a second updated data graph; determining, by the personalization component and at a fourth time, second personalization data based at least in part on the second updated data graph; and causing the output to be updated based at least in part on the second personalization data.

M. The one or more non transitory computer readable media of paragraph H, wherein the output includes user profile data comprising one of: a user identification; user browsing history; user purchase history; or user category.

N. The one or more non transitory computer readable media of paragraph H, wherein: the first user data is received from one of a first subset of data sources; and the second user data is received from one of the first subset of data sources or a second subset of data sources.

O. A method comprising: generating input data to be input to a generative machine learned model, wherein generating the input data is based at least in part on: receiving, at a real-time layer, first user data comprising a first user action at a first time, wherein the real-time layer includes a real-time data graph; based at least in part on the first user data, updating the real-time data graph of the real-time layer to generate an updated real-time data graph; determining, by a personalization component and at a second time, real-time personalization data based at least in part on the updated real-time data graph; causing an output to be generated based at least in part on the real-time personalization data; receiving, at a storage layer, the first user data, wherein the storage layer includes a data graph; based at least in part on the first user data, updating the data graph of the storage layer to generate an updated data graph; determining, by the personalization component and at a third time, personalization data based at least in part on the updated data graph; and causing the output to be updated based at least in part on the personalization data.

P. The method of paragraph O, wherein the real-time data graph is based on a data model object (DMO).

Q. The method of paragraph P, wherein the DMO is based on one or more data fields, the one or more data fields comprising one of: an email address; a phone number; a date; a time; or a Uniform Resource Locator (URL).

R. The method of paragraph O, wherein the real-time personalization data is first real-time personalization data, the updated data graph is a first updated data graph, and the output is a first output, the method further comprising: receiving, at the real-time layer, second user data comprising a second user action at a fourth time; based at least in part on the second user data, updating the first updated real-time data graph to generate a second updated real-time data graph; determining, by a model component and at the fourth time, second real-time personalization data based at least in part on the second updated real-time data graph; causing a second output to be generated based at least in part on the second real-time personalization data; and causing display of an indication of the second output at a user interface associated with the model component.

S. The method of paragraph O, wherein the personalization data is first personalization data, and the updated data graph is a first updated data graph, the method further comprising: receiving, at the storage layer, second user data comprising a second user action at a fourth time; based at least in part on the second user data, updating the first updated data graph to generate a second updated data graph; determining, by the personalization component and at a fourth time, second personalization data based at least in part on the second updated data graph; and causing the output to be updated based at least in part on the second personalization data.

T. The method of paragraph O, wherein the output includes user profile data comprising one of: a user identification; user browsing history; user purchase history; or user category.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A system comprising:
one or more processors; and
one or more non-transitory computer-readable media storing computer-executable instructions that, when executed, cause the one or more processors to perform operations comprising:
receiving, at a real-time layer, first user data comprising a first user action at a first time, wherein the real-time layer includes a real-time data graph;
based at least in part on the first user data, updating the real-time data graph of the real-time layer to generate an updated real-time data graph, wherein the real-time layer includes low latency processing instead of data consistency processing;
determining, by a personalization component and at a second time, real-time personalization data based at least in part on the updated real-time data graph;
causing an output to be generated based at least in part on the real-time personalization data;
receiving, at a storage layer, the first user data, wherein the storage layer includes a data graph;
based at least in part on the first user data, and subsequent to updating the real-time data graph of the real-time layer, updating the data graph of the storage layer to generate an updated data graph, wherein the storage layer includes the data consistency processing instead of the low latency processing of the real-time layer;
determining, by the personalization component and at a third time, personalization data based at least in part on the updated data graph; and
causing the output to be updated based at least in part on the personalization data to generate an updated output.

2. The system of claim 1, wherein the real-time data graph is based on a data model object (DMO).

3. The system of claim 2, wherein the DMO is based on one or more data fields, the one or more data fields comprising one of:
an email address;
a phone number;
a date;
a time; or
a Uniform Resource Locator (URL).

4. The system of claim 1, wherein the real-time personalization data is first real-time personalization data, the updated real-time data graph is a first updated real-time data graph, and the output is a first output, the operations further comprising:
receiving, at the real-time layer, second user data comprising a second user action at a fourth time;
based at least in part on the second user data, updating the first updated real-time data graph to generate a second updated real-time data graph;
determining, by a model component and at the fourth time, second real-time personalization data based at least in part on the second updated real-time data graph;
causing a second output to be generated based at least in part on the second real-time personalization data; and
causing display of an indication of the second output at a user interface associated with the model component.

5. The system of claim 1, wherein the personalization data is first personalization data, and the updated data graph is a first updated data graph, the operations further comprising:
receiving, at the storage layer, second user data comprising a second user action at a fourth time;
based at least in part on the second user data, updating the first updated data graph to generate a second updated data graph;
determining, by the personalization component and at a fourth time, second personalization data based at least in part on the second updated data graph; and
causing the output to be updated based at least in part on the second personalization data.

6. The system of claim 1, wherein the output or the updated output includes user profile data comprising one of:
a user identification;
user browsing history;
user purchase history; or
user category.

7. The system of claim 5, wherein:
the first user data is received from one of a first subset of data sources; and
the second user data is received from one of the first subset of data sources or a second subset of data sources.

8. One or more non-transitory computer-readable media storing instructions executable by one or more processors, wherein the instructions, when executed, cause the one or more processors to perform operations comprising:
receiving, at a real-time layer, first user data comprising a first user action at a first time, wherein the real-time layer includes a real-time data graph;
based at least in part on the first user data, updating the real-time data graph of the real-time layer to generate an updated real-time data graph, wherein the real-time layer includes low latency processing instead of data consistency processing;
determining, by a personalization component and at a second time, real-time personalization data based at least in part on the updated real-time data graph;
causing an output to be generated based at least in part on the real-time personalization data;
receiving, at a storage layer, the first user data, wherein the storage layer includes a data graph;
based at least in part on the first user data, and subsequent to updating the real-time data graph of the real-time layer, updating the data graph of the storage layer to generate an updated data graph, wherein the storage layer includes the data consistency processing instead of the low latency processing of the real-time layer;
determining, by the personalization component and at a third time, personalization data based at least in part on the updated data graph; and
causing the output to be updated based at least in part on the personalization data to generate an updated output.

9. The one or more non-transitory computer-readable media of claim 8, wherein the real-time data graph is based on a data model object (DMO).

10. The one or more non-transitory computer-readable media of claim 9, wherein the DMO is based on one or more data fields, the one or more data fields comprising one of:
an email address;
a phone number;
a date;
a time; or
a Uniform Resource Locator (URL).

11. The one or more non-transitory computer-readable media of claim 8, wherein the real-time personalization data is first real-time personalization data, the updated real-time data graph is a first updated real-time data graph, and the output is a first output, the operations further comprising:
receiving, at the real-time layer, second user data comprising a second user action at a fourth time;
based at least in part on the second user data, updating the first updated real-time data graph to generate a second updated real-time data graph;
determining, by a model component and at the fourth time, second real-time personalization data based at least in part on the second updated real-time data graph;
causing a second output to be generated based at least in part on the second real-time personalization data; and
causing display of an indication of the second output at a user interface associated with the model component.

12. The one or more non-transitory computer-readable media of claim 8, wherein the personalization data is first personalization data, and the updated data graph is a first updated data graph, the operations further comprising:
receiving, at the storage layer, second user data comprising a second user action at a fourth time;
based at least in part on the second user data, updating the first updated data graph to generate a second updated data graph;
determining, by the personalization component and at a fourth time, second personalization data based at least in part on the second updated data graph; and
causing the output to be updated based at least in part on the second personalization data.

13. The one or more non-transitory computer-readable media of claim 8, wherein the output or the updated output includes user profile data comprising one of:
a user identification;
user browsing history;
user purchase history; or
user category.

14. The one or more non-transitory computer-readable media of claim 12, wherein:
the first user data is received from one of a first subset of data sources; and
the second user data is received from one of the first subset of data sources or a second subset of data sources.

15. A method comprising:
generating input data to be input to a generative machine learned model, wherein generating the input data is based at least in part on:
receiving, at a real-time layer, first user data comprising a first user action at a first time, wherein the real-time layer includes a real-time data graph;
based at least in part on the first user data, updating the real-time data graph of the real-time layer to generate an updated real-time data graph, wherein the real-time layer includes low latency processing instead of data consistency processing;
determining, by a personalization component and at a second time, real-time personalization data based at least in part on the updated real-time data graph;
causing an output to be generated based at least in part on the real-time personalization data;
receiving, at a storage layer, the first user data, wherein the storage layer includes a data graph;
based at least in part on the first user data, and subsequent to updating the real-time data graph of the real-time layer, updating the data graph of the storage layer to generate an updated data graph, wherein the storage layer includes the data consistency processing instead of the low latency processing of the real-time layer;
determining, by the personalization component and at a third time, personalization data based at least in part on the updated data graph; and
causing the output to be updated based at least in part on the personalization data to generate an updated output.

16. The method of claim 15, wherein the real-time data graph is based on a data model object (DMO).

17. The method of claim 16, wherein the DMO is based on one or more data fields, the one or more data fields comprising one of:
an email address;
a phone number;
a date;
a time; or
a Uniform Resource Locator (URL).

18. The method of claim 15, wherein the real-time personalization data is first real-time personalization data, the updated real-time data graph is a first updated real-time data graph, and the output is a first output, the method further comprising:
receiving, at the real-time layer, second user data comprising a second user action at a fourth time;
based at least in part on the second user data, updating the first updated real-time data graph to generate a second updated real-time data graph;
determining, by a model component and at the fourth time, second real-time personalization data based at least in part on the second updated real-time data graph;
causing a second output to be generated based at least in part on the second real-time personalization data; and
causing display of an indication of the second output at a user interface associated with the model component.

19. The method of claim 15, wherein the personalization data is first personalization data, and the updated data graph is a first updated data graph, the method further comprising:
receiving, at the storage layer, second user data comprising a second user action at a fourth time;
based at least in part on the second user data, updating the first updated data graph to generate a second updated data graph;
determining, by the personalization component and at a fourth time, second personalization data based at least in part on the second updated data graph; and
causing the output to be updated based at least in part on the second personalization data.

20. The method of claim 15, wherein the output or the updated output includes user profile data comprising one of:
a user identification;
user browsing history;
user purchase history; or
user category.
